(19) United States
(12) Patent Application Publication
(10) Pub. No.: US 2026/0119155 A1
(43) Pub. Date: Apr. 30, 2026

(54) OVER-THE-AIR UPDATE SYSTEMS FOR VEHICLES

(71) Applicant: GM GLOBAL TECHNOLOGY OPERATIONS LLC, Detriot, MI (US)

(72) Inventor: Jimmy QI, Shanghai (CN)

(21) Appl. No.: 18/990,986

(22) Filed: Dec. 20, 2024

(30) Foreign Application Priority Data
Oct. 30, 2024 (CN) 2024115333843

(51) Int. Cl. G06F 8/65; H04W 4/40

(52) U.S. Cl. CPC G06F 8/65; H04W 4/40

(57) ABSTRACT

An example vehicle over-the-air (OTA) update system includes a vehicle control module configured to obtain vehicle sensor data from multiple vehicle sensors, and voice data from a vehicle microphone, obtain driving history data indicative of driving behaviors associated with the vehicle over a specified historical period, synchronize the vehicle sensor data, the voice data and the driving history data, using multiple time frames, to generate a synchronized data set, tokenize the synchronized data set to formalize embedding vectors, generate an OTA feature priority set by supplying the embedding vectors to a trained multimodal machine learning model, determine an OTA update execution schedule according to the OTA feature driver preference output, wherein the OTA execution schedule includes a first OTA update feature having a higher priority than a second OTA update feature, and control reception of OTA update data via a vehicle antenna.

### CROSS-REFERENCE TO RELATED APPLICATIONS

This application claims the benefit of Chinese Patent Application No. 202411533384.3, filed on Oct. 30, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to over-the-air (OTA) update systems for vehicles, including prioritizing OTA updates according to sensed vehicle data and driving history.

Vehicles include many control features for various vehicle systems, such as automated driving, voice commands, etc. Vehicles may receive over-the-air updates to upgrade different control systems of the vehicle.

### SUMMARY

An example vehicle over-the-air (OTA) update system includes multiple vehicle sensors each configured to detect vehicle sensor data indicative of one or more vehicle operation parameters of a vehicle, a vehicle microphone configured to capture audio from an interior of the vehicle, an antenna configured to wireless receives vehicle OTA update data, and a vehicle control module configured to obtain vehicle sensor data from the multiple vehicle sensors, and voice data from the vehicle microphone, obtain driving history data indicative of driving behaviors associated with the vehicle over a specified historical period, synchronize the vehicle sensor data, the voice data and the driving history data, using multiple time frames, to generate a synchronized data set, tokenize the synchronized data set to formalize embedding vectors for input to a trained multimodal machine learning model configured to generate an OTA feature driver preference output, generate an OTA feature priority set by supplying the embedding vectors to the trained multimodal machine learning model, determine an OTA update execution schedule according to the OTA feature driver preference output, wherein the OTA execution schedule includes a first OTA update feature having a higher priority than a second OTA update feature, and control reception of OTA update data via the antenna, according to priorities of OTA update features in the OTA update execution schedule.

In some examples, the trained multimodal machine learning model is trained to receive input data from sources having multiple modalities, and generate an output indicative of a likelihood of a driver preference with respect to multiple OTA update features.

In some examples, the trained multimodal machine learning model includes at least one of a transformer model, a neural network, a large language model (LLM), or a memory aware regression model.

In some examples, the first OTA update feature includes at least one of a voice command control feature, an adaptive cruise control feature, an advanced driver-assistance system feature, an autopilot feature, or a software-defined vehicle feature.

In some examples, controlling reception of OTA update data includes receiving an update to an advanced driver-assistance system feature, and the vehicle control module is configured to automatically control acceleration of the vehicle, braking of the vehicle, and steering of the vehicle, according to the update to the advanced driver-assistance system feature.

In some examples, obtaining vehicle sensor data includes formatting the vehicle sensor data to include a sensor dataset (I) with semantic annotated labels (L) and depth information (D) in a format of {I, L, D}, and formatting the voice data in a format of {S, W} using a large language model, where S is a raw sound signal wave and W includes recognized language words.

In some examples, synchronizing the vehicle sensor data, the voice data and the driving history data includes obtaining global positioning system (GPS) time frame data associated with the vehicle sensor data, the voice data and the driving history data, and performing the synchronization of the vehicle sensor data, the voice data and the driving history data according to the GPS time frame data.

In some examples, synchronizing the vehicle sensor data, the voice data and the driving history data includes interpolating time frames associated with the vehicle sensor data to create matching time frames associated with each element of the vehicle sensor data.

In some examples, controlling reception of OTA update data includes wirelessly receiving multiple data packets from a wireless transmitter, at the antenna of the vehicle, combining the multiple data packets to define an OTA update block, and storing the OTA update block in memory of the vehicle control module.

In some examples, controlling reception of OTA update data includes receiving a message that a first OTA upgrade is available corresponding the first OTA update feature and a second OTA upgrade is available corresponding to the second OTA update feature, receiving the first OTA upgrade according via wireless transmission to the antenna of the vehicle, and delaying reception of the second OTA upgrade feature for a specified future time period. In some examples, the specified future time period is at least one week.

An example method of controlling vehicle over-the-air (OTA) updates includes receiving, by a vehicle control module, vehicle sensor data from multiple vehicle sensors, and voice data from a vehicle microphone configured to capture audio from an interior of a vehicle, wherein the vehicle sensor data is indicative of one or more vehicle operation parameters of the vehicle, obtaining driving history data indicative of driving behaviors associated with the vehicle over a specified historical period, synchronizing the vehicle sensor data, the voice data and the driving history data using multiple time frames to generate a synchronized data set, tokenizing the synchronized data set to formalize embedding vectors for input to a trained multimodal machine learning model configured to generate an OTA feature driver preference output, generating an OTA feature priority set by supplying the embedding vectors to the trained multimodal machine learning model, determining an OTA update execution schedule according to the OTA feature driver preference output, wherein the OTA execution schedule includes a first OTA update feature having a higher priority than a second OTA update feature, and controlling reception of OTA update data via a wireless antenna of the vehicle, according to priorities of OTA update features in the OTA update execution schedule.

In some examples, the trained multimodal machine learning model is trained to receive input data from sources having multiple modalities, and generate an output indicative of a likelihood of a driver preference with respect to multiple OTA update features.

In some examples, the trained multimodal machine learning model includes at least one of a transformer model, a neural network, a large language model (LLM), or a memory aware regression model.

In some examples, the first OTA update feature includes at least one of a voice command control feature, an adaptive cruise control feature, an advanced driver-assistance system feature, an autopilot feature, or a software-defined vehicle feature.

In some examples, controlling reception of OTA update data includes receiving an update to an advanced driver-assistance system feature, and the method includes automatically controlling acceleration of the vehicle, braking of the vehicle, and steering of the vehicle, according to the update to the advanced driver-assistance system feature.

In some examples, obtaining vehicle sensor data includes formatting the vehicle sensor data to include a sensor dataset (I) with semantic annotated labels (L) and depth information (D) in a format of {I, L, D}, and formatting the voice data in a format of {S, W} using a large language model, where S is a raw sound signal wave and W includes recognized language words.

In some examples, synchronizing the vehicle sensor data, the voice data and the driving history data includes obtaining global positioning system (GPS) time frame data associated with the vehicle sensor data, the voice data and the driving history data, and performing the synchronization of the vehicle sensor data, the voice data and the driving history data according to the GPS time frame data.

In some examples, synchronizing the vehicle sensor data, the voice data and the driving history data includes interpolating time frames associated with the vehicle sensor data to create matching time frames associated with each element of the vehicle sensor data.

In some examples, controlling reception of OTA update data includes wirelessly receiving multiple data packets from a wireless transmitter, at the wireless antenna of the vehicle, combining the multiple data packets to define an OTA update block, and storing the OTA update block in memory of the vehicle control module.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a diagram of an example vehicle including an antenna configured to receive over-the-air wireless updates.

FIG. 2 is a block diagram of an example system for prioritizing vehicle OTA updates based on sensed vehicle data and driving history.

FIG. 3 is a flowchart depicting an example process for prioritizing vehicle OTA updates based on sensed vehicle data and driving history.

FIG. 4 is a flowchart depicting an example process for synchronizing sensed vehicle data and driving history during the example process of FIG. 3.

FIG. 5 is a flowchart depicting an example process for extracting driver preferences associated with OTA vehicle updates, during the example process of FIG. 3.

FIG. 6 is a flowchart depicting an example process for executing OTA vehicle updates according to a determined driver priority, during the example process of FIG. 3.

FIGS. 7A and 7B are graphical representations of example recurrent neural networks for predicting driver OTA preferences based on vehicle sensor data and driving history.

FIG. 8 is a graphical representation of layers of an example long short-term memory (LSTM) machine learning model.

FIG. 9 is a flowchart illustrating an example process for training a machine learning model.

In the drawings, reference numbers may be reused to identify similar and/or identical elements.

### DETAILED DESCRIPTION

In some example embodiments, a customized over-the-air (OTA) system for vehicle updates may leverage one or more multi-modal machine learning models to improve or optimize OTA vehicle update policies, such as OTA feature update frequencies, priorities for emergency features, user preferences, key times and feature contexts, etc. For example, the system may be configured to tokenize multimodality data, including synchronizing driving data and vehicle sensor data, and formalizing a type consistency matrix data source.

The system may be configured to extract learned features and driving preferences from the data, such as driving history data and vehicle sensor data. The learned mapping of driving preferences and OTA features may guide the improvement or optimization of OTA vehicle update policies, which may help to reduce bandwidth and cost (e.g., required to transmit OTA data to a vehicle antenna for transfer and download), and increase or maximize the efficiency of OTA related software and firmware upgrades based on real requirements of vehicle users, e.g., drivers and passengers.

Some OTA policies are based on forcefully upgrading requirements to fix firmware and software issues. The OTA procedures may not be flexible, and may be time consuming with high data exchanges needed, which do not fully meet the real requirements or OTA feature updates desired by users. In some examples herein, OTA vehicle update procedures may be based on different factors, including driver preferences, emergency levels, frequencies and relationships with OTA feature contents.

For example, driving behavior and OTA feature usage factors and corresponding metrics may be automatically extracted and learned from multimodal data from daily driving, such as vehicle sensor data, driving data and habits and event estimation. Consistency of data representation from different data sources may be maintained by the system to learn a unified model to optimize latent variables and mapping to various OTA policy targets, which may facilitate customization of OTA update feature extraction and prioritization, and OTA vehicle update policies may be ranked without introducing redundancy.

This may improve efficiency in executing OTA vehicle updates, and reducing or avoiding the need to run a full OTA vehicle update of all available update features at one time (which may require more bandwidth and time compared to executing only a subset of prioritized OTA updates based on user preferences and usage history). For example, some systems may reduce the bandwidth and optimize the OTA features based on the real requirements or desires of vehicle users (e.g., drivers and passengers), where the customized OTA vehicle update features fully meet the requirements of users regarding OTA update policy and contents. This may greatly reduce the cost of OTA updates, and maximize the efficiency of OTA related software and firmware with customized features.

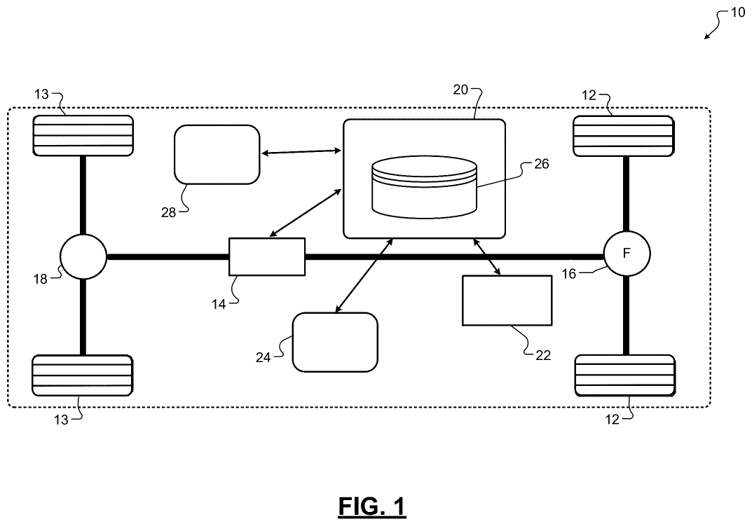

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration pedal, a brake pedal, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors 24 (such as cameras, microphones, pressure sensors, steering wheel position sensors, braking sensors, location sensors such as global positioning system (GPS) antennas, wheel height and/or position sensors, accelerometers, etc.). Some sensors may be configured to monitor current motion of the vehicle, acceleration of the vehicle, braking of the vehicle, current steering direction of the vehicle, current height and/or position of one or more wheels, etc. In some examples, a vehicle microphone 22 is configured to capture audio of an interior of the vehicle 10, such as voice commands from a driver or passenger (e.g., for control of automated driving features, hands-free navigation or entertainment features, etc.).

The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

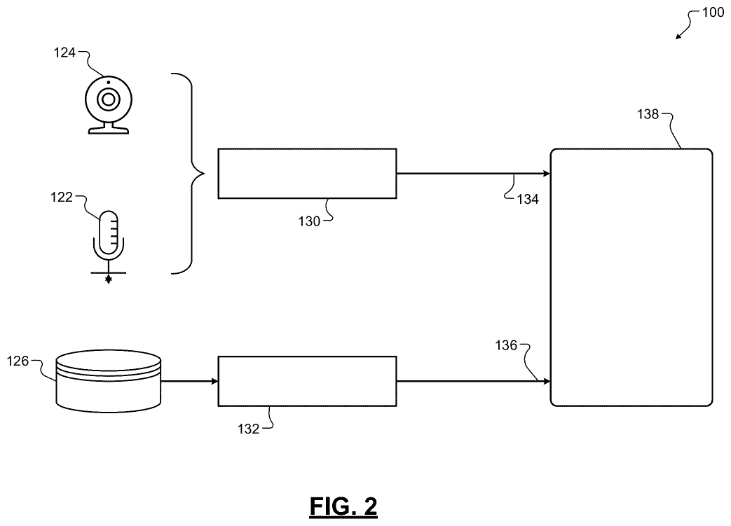

As shown in FIG. 2, the vehicle control module 20 may include an over-the-air (OTA) update antenna 28, which may be configured to receive OTA vehicle update data from an OTA server, an OTA update provider, etc. For example, a radio tower, cellular tower, satellite, WiFi router, etc., may be configured to wirelessly transmit data to the OTA update antenna 28, to implement an OTA vehicle feature upgrade. The OTA update antenna 28 may include any suitable receiver, transceiver, antenna, antenna array, etc., configured to receive the OTA vehicle update data.

The received OTA vehicle update data may be stored in a memory of the vehicle 10, such as a memory of the vehicle control module 20. The received OTA vehicle update data may be used to modify operation of vehicle software, firmware, etc. For example, the OTA vehicle update data may include an upgrade of an automated driving control system, where the vehicle control module 20 is configured to implement the OTA vehicle update to automatically control acceleration of the vehicle 10 (e.g., via an accelerator or controlling a motor of the drive unit 14 to provide more power to the front wheels 12 and the rear wheels 13), to control braking of the vehicle 10 (e.g., via brakes applied to the front wheels 12 and the rear wheels 13 or via engine breaking at a motor of the drive unit 14), to control automated steering of the vehicle 10 (e.g., by rotating a steering mechanism or directly changing an orientation of the front wheels 12), etc.

The vehicle control module 20 may store driving history data 26, such as in memory of the vehicle control module 20 or in a database. The driving history data 26 may include data obtained via a CAN bus of the vehicle, usage of automated driving features, etc.

FIG. 2 is a block diagram of an example system 100 for prioritizing vehicle OTA updates based on sensed vehicle data and driving history. As shown in FIG. 1, sensor data 124 is acquired (e.g., via the vehicle sensors 24 of FIG. 2), and may be combined with acquired speech data 122 (e.g., via the vehicle microphone 22 of FIG. 2).

For example, the sensor data 124 and speech data 122 may be combined via multimodal fusion 130, from raw data sources. The multimodal fusion 130 may generate tokens 134, which can be supplied to a feature extraction module 138 that maps vehicle sensor features to OTA vehicle update features.

Driving history data 126 may be parsed into event data 132, such as by categorizing actions in the driving history data 126 based on dates of the actions, and corresponding advanced driver-assistance system (ADAS) features. The event data 132 may include defined action relationships 136 corresponding to OTA vehicle update features, and may be supplied to the feature extraction module 138.

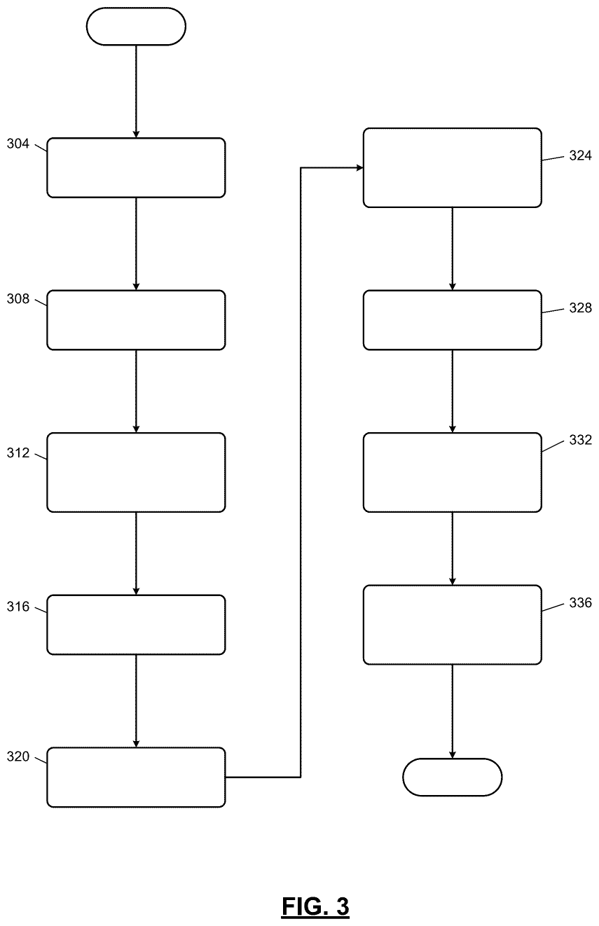

FIG. 3 is a flowchart depicting an example process for prioritizing vehicle OTA updates based on sensed vehicle data and driving history. The process may be performed by, for example, the vehicle control module 20 of FIG. 1. At 304, the process begins by obtaining input data from vehicle sensors and a vehicle microphone.

For example, the system may be configured to collect internal and external environment data of a vehicle by leveraging built-in sensors, without introducing any extra device costs. The output of the data collection component may be a sensor dataset (I) with semantic annotated labels (L) and depth information (D), in the format of {I, L, D}.

The system may also collect data of conversation contents between a driver or passenger and a voice assistant system. The voice track of each user may be labeled based on a large language model (LLM) voice model, with a data format of {S, W}, where S is the raw sound signal wave (e.g., frame by frame), and W includes recognized language words.

At 308, the vehicle control module is configured to obtain driving history data based on past vehicle motion. For example, the system may be configured to collects driving history data {H}, which covers driving behavior of a driver of the vehicle. Some driving history data inputs may be retrieved via CAN data, which continuously monitors the status of actuators in vehicles (e.g., acceleration, hard braking, a steering wheel, etc.).

In addition, the system may collect ADAS/AV related operations (e.g., switching on ACC mode, autopilot mode, attribute settings via an HMI, transfer of control operations, configurations, etc.). The information may include frequency of events, and corresponding OTA features status may also be recorded into data set (e.g., {H|ADAS/AV, Frequency, OTA features}), which may be important to map the intention of a driver to automated features.

At 312, the vehicle control module is configured to synchronize data from vehicle sensors and driving history. For example, the system may be configured to synchronize vehicle sensor data, microphone data and driving history data, by leveraging the GPS time synchronization to align time frames of each element of data. For the vehicle sensor data {I, L, D}, because the rates of frames from different sensors are different, a prediction model may be used to interpolate between frames, in order to retrieve all sensor data at the same time frames.

The system may be configured to fuse the object lists (e.g., a Bird Eye View (BEV) extracted from each sensor based on the estimated relative location to the host vehicle). This may result in complete fused semantic annotated labels (L′), aligned upon each frame from all the sensors, and the system may be configured to map the depth information (D′) to formalize the dataset in the format {l′, L′, D′| l′, L′, D′ E Camera/Lidar/Radar fusion results aligning with accurate time}.

In some examples, multimodality data sources may be fused in a preprocessing step. The data set {S,W} may be aligned with a time frame where {l′, L′, D′}. The rate of frames of sound and recognized words may be much lower than the frame rate of sensed vehicle data. This may allow determining a corresponding dataset {Vt|Vt∈(S,W) continuously across different frame of sensor data}, which pairs with certain frames of sensor data {Pt|Pt∈(I′, L′, D′)}.

After leveraging a transformer mode for Vt, and Vision Transformer (ViT) for Pt, the system may encode the data into embedding vectors, and find the similarity from Vt and Pt by using an inner dot operation Mt=(Vt*Pt). The system may also be configured to align the driving histories with the sensor data. For example, the system may be configured to use Ht to represent the behaviors of drivers in each frame t of Mt from multimodality data. The system may output fused embedding vectors Mt={Vt*Pt|Ht} from different data sources (e.g., sensor data and voice conversation).

At 316, the vehicle control module is configured to perform feature extraction and action mapping based on the synchronized data. For example, OTA feature extraction may be used to determine a frequency level of usage of an OTA feature, among different maneuvers. Based at least partially on the data set {H}, the system may be configured to map habits of a driver with the OTA feature, for each time step. An example of OTA feature usage is provided in Table 1:

TABLE 1

| Action | Date/Time | Event | OTA Feature |
|---|---|---|---|
| Casual Talking | Morning | Traffic Jam | Conversation |
| Start Autopilot | Engine start | No special | ACC / Autopilot / |
| mode | | | Super Cruise |
| Hard Brake | Time A (Rare) | Risk condition | SDV Architecture |
| Full Stop | Many | Traffic lights | ADAS |
| | Timestamps | | |
| Human Take over | Time C (Rare) | Disengagement | Autopilot |

In the sample data of Table 1, each row illustrates an action driven by a driver in each time step (e.g., the sample rate may be the same as the rate of dataset H, such as 100 Hz or more). The column ‘Date/Time’, and the ‘OTA Feature’ value, may be retrieved from the dataset H directly.

The column ‘Action’ may be mapped by using rule-based metrics, according to the dataset H. For example, the Hard Brake action may be labeled when the acceleration of the vehicle is larger than −3G˜−6G. The column ‘Event’ may be learned from the data Mt by using a supervised learning procedure, such as a neural network trained with a hidden variable to estimate the Event according to the surrounding information and behavior of a driver (e.g., a traffic jam event and a traffic light event may be learned by surrounding information from the sensor data). If there is lower confidence of the ‘Event’ probability output, the system may identify an Event as “not special” by default.

At 320, the vehicle control module is configured to tokenize data for input to a trained machine learning model. For example, a tokenizer may be used to formalize embedding vectors Mt according to different frames, into tokens which are recognizable by a multi-modal training model. The multi-model training model may be configured to identify different policies of OTA updates according to different driving behaviors. Because Mt may already be time-aligned, and the embedded vectors may have consistent representation of different data sources, the unified multi-modal LLM training model may be configured to learn latent variables Z via neural networks Z=LLM (Mt), and generalize into the OTA policies (e.g., frequency of OTA feature usage, emergency level, execution time according to certain OTA features, etc.).

In some examples, the policy may be represented at least partially as Policy˜df (Z). Because an LLM model may be used, the policy item of an OTA feature may be self-estimated based on the driver's behavior. For example, the OTA policy feature related to ACC only have a preference regarding update frequency, while an OTA related to the feature of ADAS may have a preference regarding security and enhancement updates.

At 324, the vehicle control module is configured to extract driving preferences based on processed data. For example, the driving preference may be estimated based on the driving behavior history and related operations. In some examples, a memory aware regression model may be leveraged to predict the driving preferences according to usage frequency, launching time and duration of usage, of OTA features. The output of this component may be a mapping between the operation preferences of each OTA feature (e.g., ADAS-always ON, ACC-OFF, voice assistant-On demand, etc.).

At 328, the vehicle control module is configured to prioritize over-the-air features using an output of the model. For example, OTA features may be ranked based on mapped driver preferences and probability values of OTA policies, such as by using an equation of Rank=Σweight*softmax (p(Policy)), which is mapped to driver preference. OTA feature extraction and prioritization may be customized without introducing redundancy, to guide the OTA features to be executed efficiently (which may avoid a need to run all available OTA procedures at once).

At 332, the vehicle control module is configured to set an OTA transfer schedule based on the determined OTA feature priority. For example, the OTA strategy may be improved or optimized based on the ranking and attributes learned from previous steps. Ane example OTA transfer schedule is illustrated in Table 2:

TABLE 2

| | OTA | | | |
|---|---|---|---|---|
| OTA Feature | Time | Emergency | Preference | Frequency |
| Conversation | Casual Time | LOW | ON | Every |
| | | | | week |
| ACC / Autopilot / | Driving - | HIGH | OFF | Every day |
| Super Cruise | real time | | | |
| SDV Architecture | Important | HIGH | ON / | Every |
| | Time | | ALWAYS | month |
| ADAS | Driving - | MID | ON / Nice to | Every day |
| | stop time | | have | |
| Autopilot | Driving - | HIGH | ON | Every |
| | real time | | | hour |

At 336, the vehicle control module is configured to execute OTA transfers to a vehicle, according to the OTA transfer schedule. Some example embodiments may help to reduce the bandwidth used for OTA feature updates, and optimize the OTA features based on the needs of vehicle users. The customized OTA features may fully meet the needs of users to update policy and contents. This may greatly reduce the cost, and increase or maximize the efficiency of OTA related software and firmware with customized features.

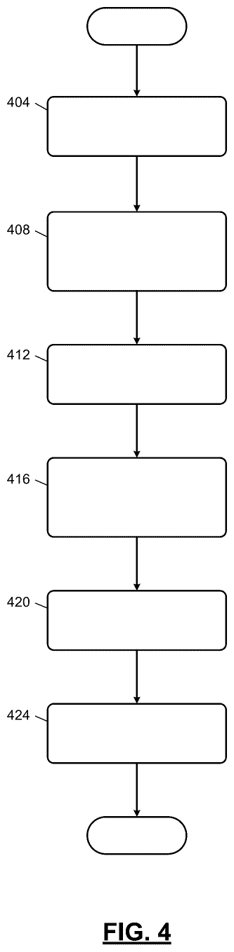

FIG. 4 is a flowchart depicting an example process for synchronizing sensed vehicle data and driving history during the example process of FIG. 3. The process may be performed by, for example, the vehicle control module 20 of FIG. 1. At 404, the process begins by obtaining a sensor dataset (I) with semantic labels (L) and depth information (D). For example, the sensor dataset may be obtained from signals detected by the vehicle sensors.

At 408, the vehicle control module is configured to label conversation data using a large language model. The labeled data may include raw sound signal waves(S), and recognized language words (W). At 412, the vehicle control module is configured to retrieve CAN data (e.g., via a CAN bus of the vehicle), and ADAS related operations.

At 416, control records the driving history data into a dataset, which may include frequency of driving history events or usage, OTA features associated with the driving history events, etc. The vehicle control module is configured to align time frames of the data using global positioning system (GPS) time synchronization at 420. The vehicle control module is configured to fuse embedding vectors for each time frame for different data sources, at 424.

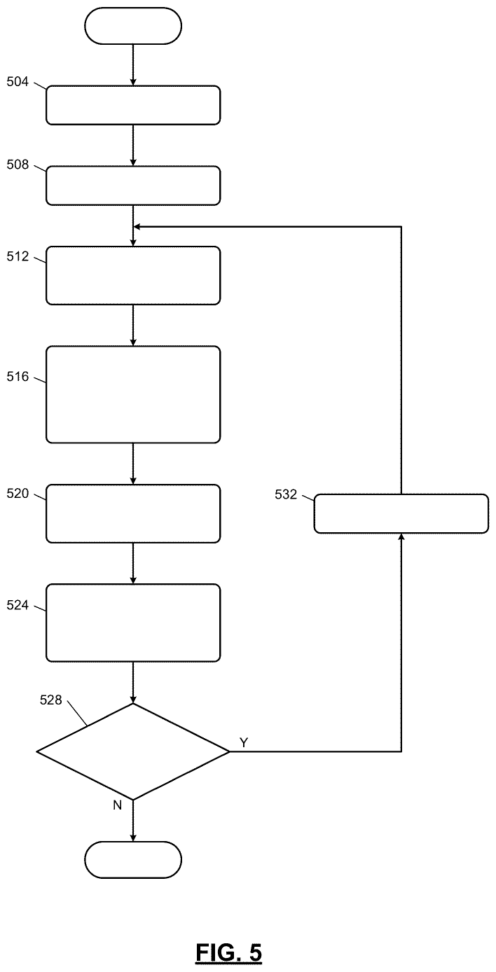

FIG. 5 is a flowchart depicting an example process for extracting driver preferences associated with OTA vehicle updates, during the example process of FIG. 3. The process may be performed by, for example, the vehicle control module 20 of FIG. 1. At 504, the process begins by accessing a list of OTA features. Control then selects a first OTA feature from the list at 508.

At 512, the vehicle control module is configured to obtain driving behavior data related to the selected OTA feature. Control then determines, at 516, a usage frequency of the selected OTA feature, a launch time of events related to the selected OTA feature, usage duration of the selected OTA feature, etc.

At 520, the vehicle control module is configured to predict driving preferences using, e.g., a memory aware regression module. Control then generates a mapping between operation preferences of the driver, and associated OTA features, based on the model output, at 524.

At 528, the vehicle control module is configured to determine whether any additional OTA features are remaining on the list. If so, control proceeds to 532 to select a next OTA feature from the list, and then returns to 512 to obtaining driving behavior data related to the next selected OTA feature.

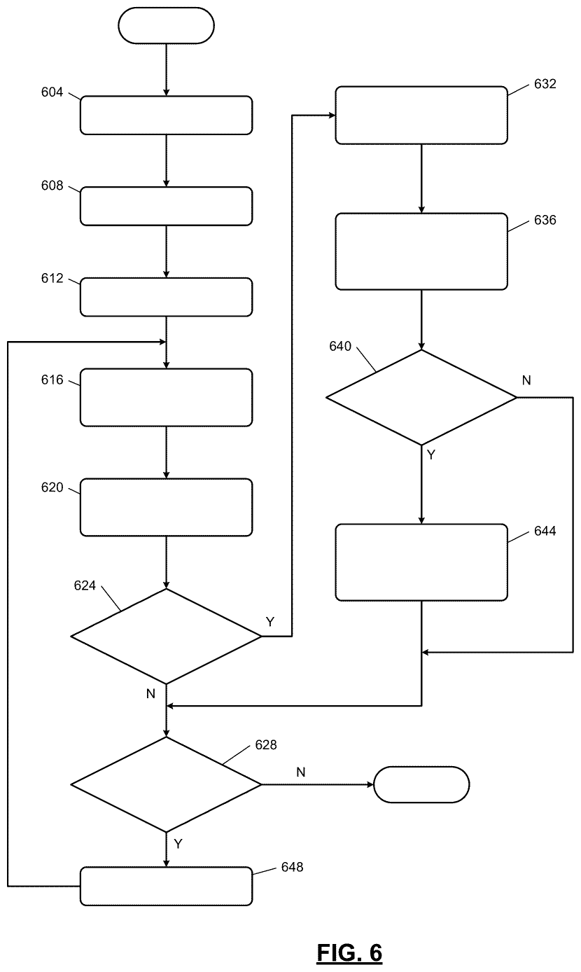

FIG. 6 is a flowchart depicting an example process for executing OTA vehicle updates according to a determined driver priority, during the example process of FIG. 3. The process may be performed by, for example, the vehicle control module 20 of FIG. 1. At 604, the process begins by obtaining a driver OTA feature preference list.

At 608, the vehicle control module is configured to access a list of available OTA updates (e.g., a current list of OTA features stored at an update server, which have a more recent version than a currently installed version on the vehicle, and are available for wireless transfer to the vehicle for download and updating).

At 612, control selects a first available OTA update from the list. Control then obtains a last vehicle OTA update time for the selected available OTA feature update at 616 (e.g., a timestamp of the last reception of an update transferred to the vehicle, for the selected OTA update feature).

At 620, the vehicle control module is configured to compare the last update time with a driver OTA preference time period. For example, the driver OTA preference time period may indicate that ADAS features should only be updated once a month. The vehicle control module may be configured to only obtain the latest OTA update related to ADAS features, if it has been at least one month since the last ADAS feature OTA update was received at the vehicle.

If an OTA update is indicated at 624 (e.g., because the last OTA update received for the selected feature was at least longer ago than a specified interval based on the determined OTA feature priority for the driver), control proceeds to 632 to receive an OTA update via wireless transfer to an antenna of the vehicle.

At 636, the vehicle control module is configured to update the vehicle control system, which may include storing the received OTA update data in memory of the vehicle, installing the OTA update features or upgrading control software or firmware of the vehicle based on the OTA update data, etc.

At 640, control determines whether the OTA update feature includes any ADAS features. If so, control proceeds to 644 to automatically control acceleration of the vehicle, braking of the vehicle, and steering of the vehicle, according to the received OTA update feature.

After storing or implementing the updated OTA feature, or determining at 624 that an OTA update is not to be executed due to lower priority of the OTA feature, control proceeds to 628 to determine whether there are any OTA updates remaining. If so, control selects a next available OTA update at 648, and returns to 616 to obtain a last vehicle OTA update time for the next available OTA update feature.

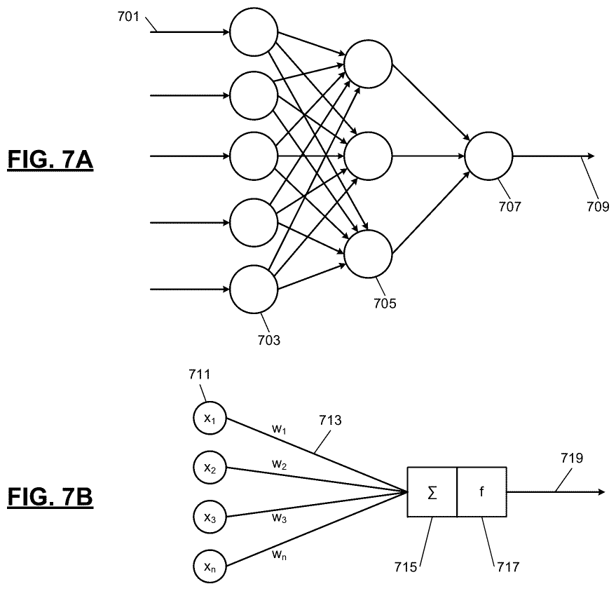

FIGS. 7A and 7B show an example of a recurrent neural network used to generate models such as those described above, using machine learning techniques. Machine learning is a method used to devise complex models and algorithms that lend themselves to prediction (for example, patient and provider matching predictions). The models generated using machine learning, such as those described above, can produce reliable, repeatable decisions and results, and uncover hidden insights through learning from historical relationships and trends in the data.

The purpose of using the recurrent neural-network-based model, and training the model using machine learning as described above, may be to directly predict dependent variables without casting relationships between the variables into mathematical form. The neural network model includes a large number of virtual neurons operating in parallel and arranged in layers. The first layer is the input layer 703 and receives raw input data 701. Each successive layer modifies outputs from a preceding layer and sends them to a next layer. The last layer is the output layer 707 and produces output 709 of the system.

FIG. 7A shows a fully connected neural network, where each neuron in a given layer is connected to each neuron in a next layer. In the input layer, each input node is associated with a numerical value, which can be any real number. In each layer, each connection that departs from an input node has a weight associated with it, which can also be any real number (see FIG. 7B). In the input layer, the number of neurons equals the number of features (columns) in a dataset. The output layer may have multiple continuous outputs.

The layers between the input layers 703 and output layers 707 are hidden layers 705. The number of hidden layers can be one or more (one hidden layer may be sufficient for most applications). A neural network with no hidden layers can represent linear separable functions or decisions. A neural network with one hidden layer can perform continuous mapping from one finite space to another. A neural network with two hidden layers can approximate any smooth mapping to any accuracy.

The number of neurons can be optimized. At the beginning of training, a network configuration is more likely to have excess nodes. Some of the nodes may be removed from the network during training that would not noticeably affect network performance. For example, nodes with weights approaching zero after training can be removed (this process is called pruning). The number of neurons can cause under-fitting (inability to adequately capture signals in dataset) or over-fitting (insufficient information to train all neurons; network performs well on training dataset but not on test dataset).

Various methods and criteria can be used to measure the performance of a neural network model. For example, root mean squared error (RMSE) measures the average distance between observed values and model predictions. Coefficient of Determination (R2) measures correlation (not accuracy) between observed and predicted outcomes. This method may not be reliable if the data has a large variance. Other performance measures include irreducible noise, model bias, and model variance. A high model bias for a model indicates that the model is not able to capture true relationship between predictors and the outcome. Model variance may indicate whether a model is stable (a slight perturbation in the data will significantly change the model fit). The neural network can receive inputs, e.g., vectors, which can be used to generate models that can be used with predicting vehicle OTA update priorities for a driver, based on vehicle sensor data and driving history.

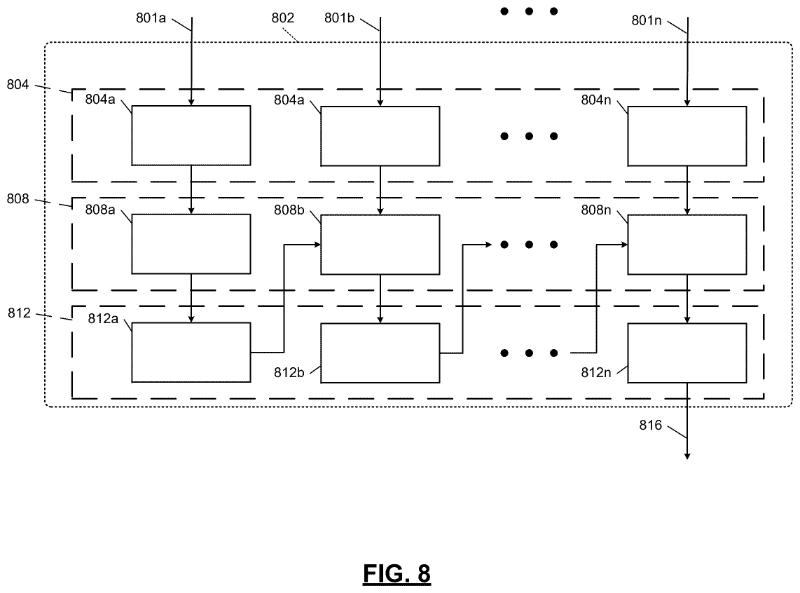

FIG. 8 illustrates an example of a long short-term memory (LSTM) neural network 802 used to generate models such as those described above, using machine learning techniques, although other example embodiments may include other types of machine learning models including transformer layers, other model topologies, etc. The generic example LSTM neural network 802 may be used to implement a machine learning model, and various implementations may use other types of machine learning networks (such as transformer layers, other model topologies or architectures, etc.). The LSTM neural network 802 includes an input layer 804, a hidden layer 808, and an output layer 812. The input layer 804 includes inputs 804a, 804b . . . 804n, which may correspond to input data 801a, 801a . . . 801n. The hidden layer 808 includes neurons 808a, 808b . . . 808n. The output layer 812 includes outputs 812a, 812b . . . 812n.

Each neuron of the hidden layer 808 receives an input from the input layer 804 and outputs a value to the corresponding output in the output layer 812. For example, the neuron 808a receives an input from the input 804a and outputs a value to the output 812a. Each neuron, other than the neuron 808a, also receives an output of a previous neuron as an input. For example, the neuron 808b receives inputs from the input 804b and the output 812a. In this way the output of each neuron is fed forward to the next neuron in the hidden layer 808. The last output 812n in the output layer 812 outputs a probability 816 associated with the inputs 804a-804n. Although the input layer 804, the hidden layer 808, and the output layer 812 are depicted as each including three elements, each layer may contain any number of elements.

In various implementations, each layer of the LSTM neural network 802 must include the same number of elements as each of the other layers of the LSTM neural network 802. In some example embodiments, a convolutional neural network may be implemented. Similar to LSTM neural networks, convolutional neural networks include an input layer, a hidden layer, and an output layer. However, in a convolutional neural network, the output layer includes one less output than the number of neurons in the hidden layer and each neuron is connected to each output. Additionally, each input in the input layer is connected to each neuron in the hidden layer. In other words, input 804a is connected to each of neurons 808a, 808b . . . 808n.

In various implementations, each input node in the input layer may be associated with a numerical value, which can be any real number. In each layer, each connection that departs from an input node has a weight associated with it, which can also be any real number. In the input layer, the number of neurons equals number of features (columns) in a dataset. The output layer may have multiple continuous outputs.

As mentioned above, the layers between the input and output layers are hidden layers. The number of hidden layers can be one or more (one hidden layer may be sufficient for many applications). A neural network with no hidden layers can represent linear separable functions or decisions. A neural network with one hidden layer can perform continuous mapping from one finite space to another. A neural network with two hidden layers can approximate any smooth mapping to any accuracy. The neural network of FIG. 8 can receive inputs, e.g., vectors, which can be used to generate models that can be used, for example, to predict OTA vehicle update preferences of a driver, based on vehicle sensor data and driving history.

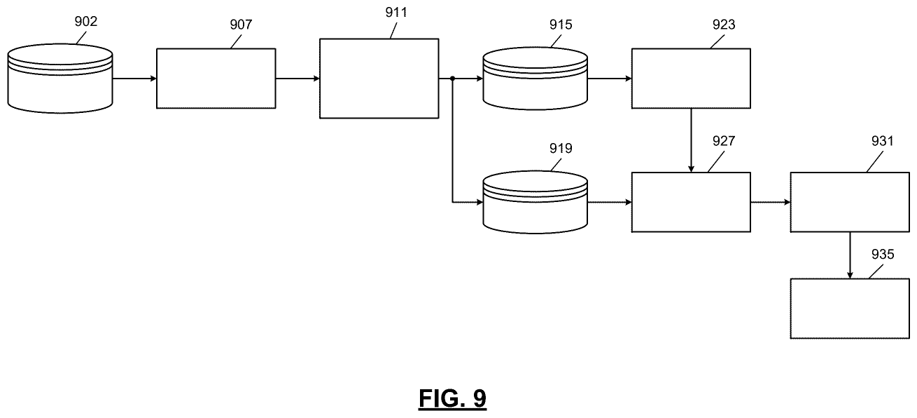

FIG. 9 illustrates an example process for generating a machine learning model. At 907, control obtains data from a database 902 (e.g., a data warehouse). The data may include any suitable data for developing machine learning models.

At 911, control separates the data obtained from the database 902 into training data 915 and test data 919. The training data 915 is used to train the model at 923, and the test data 919 is used to test the model at 927. Typically, the set of training data 915 is selected to be larger than the set of test data 919, depending on the desired model development parameters. For example, the training data 915 may include about seventy percent of the data acquired from the database 902, about eighty percent of the data, about ninety percent, etc. The remaining thirty percent, twenty percent, or ten percent, is then used as the test data 919. Separating a portion of the acquired data as test data 919 allows for testing of the trained model against actual output data, to facilitate more accurate training and development of the model at 923 and 927. The model may be trained at 923 using any suitable machine learning model techniques, including those described herein, such as random forest, generalized linear models, decision tree, and neural networks.

At 931, control evaluates the model test results. For example, the trained model may be tested at 927 using the test data 919, and the results of the output data from the tested model may be compared to actual outputs of the test data 919, to determine a level of accuracy. The model results may be evaluated using any suitable machine learning model analysis, such as the example techniques described further below.

After evaluating the model test results at 931, the model may be deployed at 935 if the model test results are satisfactory. Deploying the model may include using the model to make predictions for a large-scale input dataset with unknown outputs. If the evaluation of the model test results at 931 is unsatisfactory, the model may be developed further using different parameters, using different modeling techniques, using other model types, etc. The machine learning model method of FIG. 9 can receive inputs, e.g., vectors, which can be used to generate models that can be used, for example, to predict OTA vehicle update preferences of a driver, based on vehicle sensor data and driving history.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle over-the-air (OTA) update system comprising:
multiple vehicle sensors each configured to detect vehicle sensor data indicative of one or more vehicle operation parameters of a vehicle;
a vehicle microphone configured to capture audio from an interior of the vehicle;
an antenna configured to wireless receives vehicle OTA update data; and
a vehicle control module configured to:
obtain vehicle sensor data from the multiple vehicle sensors, and voice data from the vehicle microphone;
obtain driving history data indicative of driving behaviors associated with the vehicle over a specified historical period;
synchronize the vehicle sensor data, the voice data and the driving history data, using multiple time frames, to generate a synchronized data set;
tokenize the synchronized data set to formalize embedding vectors for input to a trained multimodal machine learning model configured to generate an OTA feature driver preference output;
generate an OTA feature priority set by supplying the embedding vectors to the trained multimodal machine learning model;
determine an OTA update execution schedule according to the OTA feature driver preference output, wherein the OTA execution schedule includes a first OTA update feature having a higher priority than a second OTA update feature; and
control reception of OTA update data via the antenna, according to priorities of OTA update features in the OTA update execution schedule.

2. The vehicle OTA update system of claim 1, wherein the trained multimodal machine learning model is trained to receive input data from sources having multiple modalities, and generate an output indicative of a likelihood of a driver preference with respect to multiple OTA update features.

3. The vehicle OTA update system of claim 1, wherein the trained multimodal machine learning model includes at least one of a transformer model, a neural network, a large language model (LLM), or a memory aware regression model.

4. The vehicle OTA update system of claim 1, wherein the first OTA update feature includes at least one of a voice command control feature, an adaptive cruise control feature, an advanced driver-assistance system feature, an autopilot feature, or a software-defined vehicle feature.

5. The vehicle OTA update system of claim 4, wherein:
controlling reception of OTA update data includes receiving an update to an advanced driver-assistance system feature; and
the vehicle control module is configured to automatically control acceleration of the vehicle, braking of the vehicle, and steering of the vehicle, according to the update to the advanced driver-assistance system feature.

6. The vehicle OTA update system of claim 1, wherein obtaining vehicle sensor data includes:
formatting the vehicle sensor data to include a sensor dataset (I) with semantic annotated labels (L) and depth information (D) in a format of {I, L, D}; and
formatting the voice data in a format of {S, W} using a large language model, where S is a raw sound signal wave and W includes recognized language words.

7. The vehicle OTA update system of claim 1, wherein synchronizing the vehicle sensor data, the voice data and the driving history data includes:
obtaining global positioning system (GPS) time frame data associated with the vehicle sensor data, the voice data and the driving history data; and
performing the synchronization of the vehicle sensor data, the voice data and the driving history data according to the GPS time frame data.

8. The vehicle OTA update system of claim 7, wherein synchronizing the vehicle sensor data, the voice data and the driving history data includes interpolating time frames associated with the vehicle sensor data to create matching time frames associated with each element of the vehicle sensor data.

9. The vehicle OTA update system of claim 1, wherein controlling reception of OTA update data includes:
wirelessly receiving multiple data packets from a wireless transmitter, at the antenna of the vehicle;
combining the multiple data packets to define an OTA update block; and
storing the OTA update block in memory of the vehicle control module.

10. The vehicle OTA update system of claim 1, controlling reception of OTA update data includes:
receiving a message that a first OTA upgrade is available corresponding the first OTA update feature and a second OTA upgrade is available corresponding to the second OTA update feature;
receiving the first OTA upgrade according via wireless transmission to the antenna of the vehicle; and
delaying reception of the second OTA upgrade feature for a specified future time period.

11. The vehicle OTA update system of claim 10, wherein the specified future time period is at least one week.

12. A method of controlling vehicle over-the-air (OTA) updates, the method comprising:
receiving, by a vehicle control module, vehicle sensor data from multiple vehicle sensors, and voice data from a vehicle microphone configured to capture audio from an interior of a vehicle, wherein the vehicle sensor data is indicative of one or more vehicle operation parameters of the vehicle;
obtaining driving history data indicative of driving behaviors associated with the vehicle over a specified historical period;
synchronizing the vehicle sensor data, the voice data and the driving history data using multiple time frames to generate a synchronized data set;
tokenizing the synchronized data set to formalize embedding vectors for input to a trained multimodal machine learning model configured to generate an OTA feature driver preference output;
generating an OTA feature priority set by supplying the embedding vectors to the trained multimodal machine learning model;
determining an OTA update execution schedule according to the OTA feature driver preference output, wherein the OTA execution schedule includes a first OTA update feature having a higher priority than a second OTA update feature; and
controlling reception of OTA update data via a wireless antenna of the vehicle, according to priorities of OTA update features in the OTA update execution schedule.

13. The method of claim 12, wherein the trained multimodal machine learning model is trained to receive input data from sources having multiple modalities, and generate an output indicative of a likelihood of a driver preference with respect to multiple OTA update features.

14. The method of claim 12, wherein the trained multimodal machine learning model includes at least one of a transformer model, a neural network, a large language model (LLM), or a memory aware regression model.

15. The method of claim 12, wherein the first OTA update feature includes at least one of a voice command control feature, an adaptive cruise control feature, an advanced driver-assistance system feature, an autopilot feature, or a software-defined vehicle feature.

16. The method of claim 15, wherein:
controlling reception of OTA update data includes receiving an update to an advanced driver-assistance system feature; and
the method includes automatically controlling acceleration of the vehicle, braking of the vehicle, and steering of the vehicle, according to the update to the advanced driver-assistance system feature.

17. The method of claim 12, wherein obtaining vehicle sensor data includes:
formatting the vehicle sensor data to include a sensor dataset (I) with semantic annotated labels (L) and depth information (D) in a format of {I, L, D}; and
formatting the voice data in a format of {S, W} using a large language model, where S is a raw sound signal wave and W includes recognized language words.

18. The method of claim 12, wherein synchronizing the vehicle sensor data, the voice data and the driving history data includes:
obtaining global positioning system (GPS) time frame data associated with the vehicle sensor data, the voice data and the driving history data; and
performing the synchronization of the vehicle sensor data, the voice data and the driving history data according to the GPS time frame data.

19. The method of claim 18, wherein synchronizing the vehicle sensor data, the voice data and the driving history data includes interpolating time frames associated with the vehicle sensor data to create matching time frames associated with each element of the vehicle sensor data.

20. The method of claim 12, wherein controlling reception of OTA update data includes:
wirelessly receiving multiple data packets from a wireless transmitter, at the wireless antenna of the vehicle;
combining the multiple data packets to define an OTA update block; and
storing the OTA update block in memory of the vehicle control module.
